(19) United States
(12) Patent Application Publication
(10) Pub. No.: US 2008/0305745 A1
(43) Pub. Date: Dec. 11, 2008

(54) METHOD AND APPARATUS FOR SUPPORTING UPLINK TRANSMISSION OF CHANNEL QUALITY AND CODING INFORMATION IN A WIRELESS COMMUNICATION SYSTEM

(75) Inventors: Guodong Zhang, Farmingdale, NY (US); Robert Lind Olesen, Huntington, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/131,345

(22) Filed: Jun. 2, 2008

Related U.S. Application Data
(60) Provisional application No. 60/942,013, filed on Jun. 5, 2007.

(51) Int. Cl. H04B 17/00

(52) U.S. Cl. 455/67.11

(57) ABSTRACT

A method and apparatus for feedback in a wireless transmit receive unit (WTRU) includes transmitting feedback over an aggregate of predefined control channel elements (CCEs) wherein the feedback is one of a channel quality indicator (CQI), a precoding matrix index (PMI) or a rank index.

### CROSS REFERENCE TO RELATED APPLICATIONS

This application claims the benefit of U.S. provisional application No. 60/942,013, filed Jun. 5, 2007, which is incorporated by reference as if fully set forth.

### FIELD OF INVENTION

This application is related to wireless communications.

### BACKGROUND

A goal of the Third Generation Partnership Project (3GPP) Long Term Evolution (LTE) program is to develop new technology, new architecture and new methods for settings and configurations in wireless communication systems in order to improve spectral efficiency, reduce latency and better utilize the radio resource to bring faster user experiences and richer applications and services to users with lower costs.

Wireless communication systems usually require feedback signaling to enable uplink and downlink communications. For example, hybrid automatic retransmission request (HARQ) enablement requires acknowledge/negative-acknowledge (ACK/NACK) feedback. Adaptive modulation and coding (AMC) requires channel quality index (CQI) feedback from a receiver. Multiple Input/Multiple Output (MIMO) systems or preceding requires rank and/or precoding matrix index (PMI) feedback from a receiver. Efficient signaling is essential to an evolved universal mobile telephone system (UMTS) terrestrial radio access network (E-UTRAN).

A wireless transmit receive unit (WTRU) may feedback a channel quality index (CQI) or a preceding matrix index (PMI) or antenna weight to a base station (BS) or an e Node B (eNB).

CQI and PMI feedback may be reported on the physical uplink control channel (PUCCH) or the physical uplink shared channel (PUSCH) in specific reporting modes. Each mode specifies the subbands for which feedback is reported and the mechanism for reporting. For example, if wideband CQI and no PMI is reported, mode 1-0 may be used. Mode 1-0 includes, for example, instruction for the WTRU to report a rank index by reporting a type 3 report that includes one rank index, and instructions for the WTRU to report CQI in a type 4 report including one wideband CQI. For other combinations of CQI and PMI, other modes may be used that include other specific instructions.

Generally, feedback reporting on the PUSCH allows for a greater variety of feedback modes, and allows a greater number of bits to be transmitted in a single transmission time interval (TTI). Feedback reporting on the PUCCH may require splitting the feedback across multiple TTIs.

Each PMI may be represented by L bits. The value of L depends upon the multiple input/multiple output (MIMO) antenna configuration and codebook sizes. A WTRU may report one PMI per subband that is selected by the WTRU or configured by an eNB. The WTRU may also report one CQI per codeword.

As the number of the feedback bits becomes larger, it may be desirable to have more efficient feedback mechanisms.

### SUMMARY

Disclosed is a method and apparatus for feedback signaling in a wireless communication system. The feedback may include channel quality index (CQI), precoding matrix index (PMI), rank and/or acknowledge/negative-acknowledge (ACK/NACK). A WTRU may perform a method that includes several different report modes providing a PMI, CQI, rank index and/or ACK/NACK and transmitting the PMI, CQI rank index and/or ACK/NACK over an aggregation of predefined channel control elements (CCEs).

### BRIEF DESCRIPTION OF THE DRAWINGS

A more detailed understanding of the invention may be had from the following description, given by way of example, and to be understood in conjunction with the accompanying drawings wherein:

FIG. 1 shows a wireless communication system including a plurality of WTRUs and an eNB;

FIG. 2 is a functional block diagram of the WTRU and the eNB of the wireless communication system of FIG. 1;

FIG. 3 shows the use of CCEs to transmit CQI and PMI; and

FIG. 4 shows the use of CCEs to transmit CQI and PMI with ACK/NACK bits.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

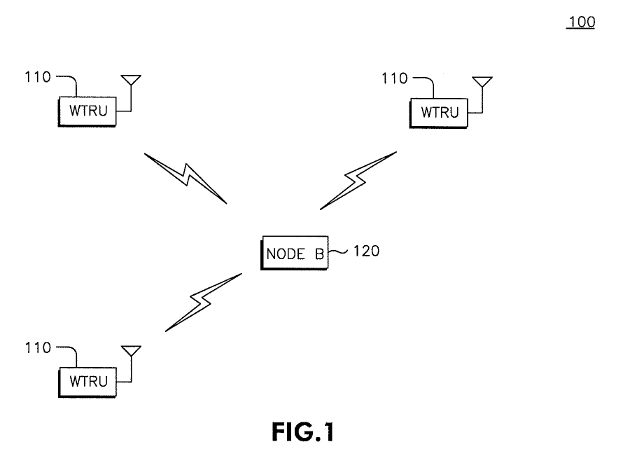

FIG. 1 shows a wireless communication system 100 including a plurality of WTRUs 110 and an eNB 120. As shown in FIG. 1, the WTRUs 110 are in communication with the eNB 120. Although three WTRUs 110 and one eNB 120 are shown in FIG. 1, it should be noted that any combination of wireless and wired devices may be included in the wireless communication system 100. Each WTRU 110 may report feedback bits on a periodic or aperiodic basis to the eNB 120. The eNB 120 may configure the type of feedback reported and the timing of the feedback.

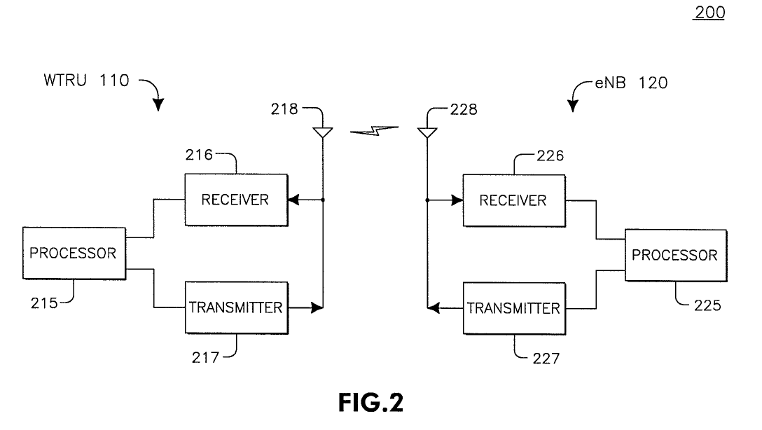

FIG. 2 is a functional block diagram 200 of the WTRU 110 and the eNB 120 of the wireless communication system 100 of FIG. 1. As shown in FIG. 2, the WTRU 110 is in communication with the eNB 120. The WTRU 110 is configured to transmit feedback signals and control signals to the eNB 120. The WTRU 110 is also configured to determine CQI and PMI as configured by the eNB 120 and to transmit the feedback and control signals to the eNB 120 on a periodic or aperiodic basis. Both the eNB 120 and the WTRU 110 are configured to process signals that are modulated and coded.

In addition to the components that may be found in a typical WTRU, the WTRU 110 includes a processor 215, a receiver 216, a transmitter 217, and an antenna 218. The receiver 216 and the transmitter 217 are in communication with the processor 215. The antenna 218 is in communication with both the receiver 216 and the transmitter 217 to facilitate the transmission and reception of wireless data.

In addition to the components that may be found in a typical eNB, the eNB 120 includes a processor 225, a receiver 226, a transmitter 227, and an antenna 228. The receiver 226 and the transmitter 227 are in communication with the processor 225. The antenna 228 is in communication with both the receiver 226 and the transmitter 227 to facilitate the transmission and reception of wireless data.

A WTRU may transmit CQI feedback, PMI feedback and/or rank index feedback to an eNB. While this disclosure makes reference to PMI, CQI, and rank index, one skilled in the art should recognize that other feedback signals may also be used.

A channel control element (CCE) may be defined as J resource elements, where J is an integer value and a resource element is defined as a specific sub-carrier during a specific orthogonal frequency division multiplex (OFDM) symbol interval. A fixed size uplink channel control element may be defined and used to carry uplink CQI, PMI and rank information. The size of the CCE may depend on many factors, including, but not limited to, the minimum size of a WTRU feedback report, system load, quality of service (QoS), and bandwidth. For each reporting period, or feedback instance, a different number of CCEs may be used, based on the aforementioned factors.

The number of CCEs used to transmit the feedback may be determined for each feedback instance, and may change from one feedback instance to the next. The number of CCEs may depend on the number of feedback bits that are going to be transmitted in any feedback instance. The WTRU may determine the number of CCEs required for any particular feedback instance.

PMI may be reported in different types of formats. PMI may be based on the feedback mode, which may be based on the uplink channel and the type of feedback that is being reported. In a first PMI format, a non-differential PMI may be used. Non-differential PMI may be used, for example, when a WTRU resets the PMI. The number of resource blocks represented by a PMI may be configured by a higher layer, such as a MAC or RLC, for example.

In a second PMI format, the PMI may be reported differentially. The difference between the PMI of a sub-frame and the last reported full PMI is reported. The measurement of the sub-frame PMI may be based on the feedback mode, similar to the full PMI.

CQI may be reported in at least one of three formats. In a first CQI format, a wideband average CQI, may be used. Wideband CQI is an average of all CQIs across all the subbands of a particular bandwidth.

In a second CQI format, a best M, or preferred M, average CQI may be reported. Hereinafter, the terms “best M” and “preferred M” may be considered synonymous and interchangeable. The best M average CQI may be a frequency-selective CQI. The best M average CQI is the average of the best M subband CQIs chosen from all the subbands, where M is an integer. The best M average CQI is chosen by the WTRU and may be reported on the physical uplink shared channel (PUSCH) or on the physical uplink control channel (PUCCH).

In a third CQI format, CQI may be reported as a best M individual CQI from amongst all the subbands. The best M individual CQI may also be a frequency-selective CQI. This is subband CQI and may be configured by a higher layer, such as a medium access control (MAC) or radio link control (RLC), for example. Best M individual CQI may also be reported on the PUSCH or on the PUCCH.

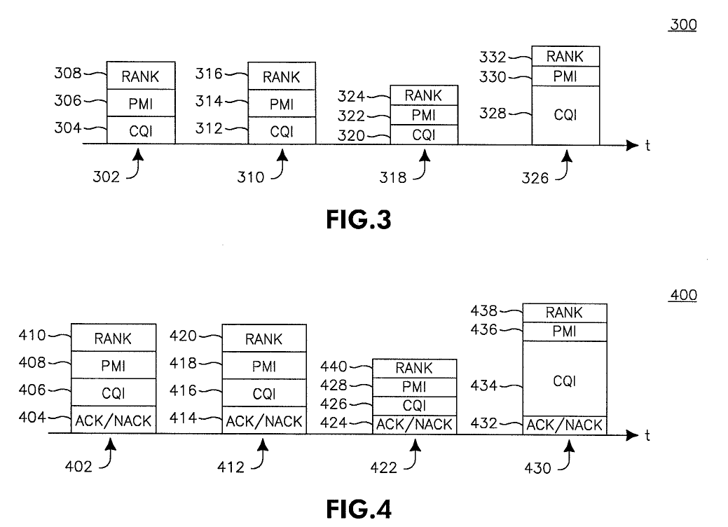

FIG. 3 shows the use of a first set of CCEs 300 to transmit CQI and PMI formats. A rank index, a PMI and a CQI can be reported in 1, 2 or 3 CCEs 300, depending on the format of the PMI and the format of the CQI. In a first feedback signal 302, two (2) CCEs 300 may be used to transmit a best M average CQI 304, a differential PMI 306 and a rank index 308. In a second feedback signal 310, a wideband CQI 312, a full PMI 314 and a rank index 316 are also transmitted in two (2) CCEs 300. In a third feedback signal 318, a wideband CQI 320, a differential PMI 322 and a rank index 324 may be transmitted in one (1) CCE. In a fourth feedback signal 326, an individual best M CQI 328, a differential PMI 330 and a rank index 332 may be transmitted in three (3) CCEs.

ACK/NACK signaling occurs regularly in a wireless network and is on-demand. It is generally driven by downlink data traffic. An ACK/NACK transmission from a WTRU to an eNB may coincide with CQI, PMI, and/or rank feedback reporting. In that case, the ACK/NACK bits may be transmitted with the feedback bits in the defined aggregate CCEs.

FIG. 4 shows the use of a second set of CCEs 400 to transmit CQI and PMI with ACK/NACK bits. A rank index, a PMI, a CQI and an ACK/NACK can be reported in 1, 2 or 3 CCEs 400, depending on the format of the PMI and the format of the CQI. For example, in a first feedback signal 402, two (2) CCEs 400 may be used to transmit a best M average CQI 406, a differential PMI 408, a rank index 410 and an ACK/NACK 404. In a second feedback signal 412, a wideband CQI 416, a full PMI 418, a rank index 420 and an ACK/NACK 414 are also transmitted in two (2) CCEs 400. In a third feedback signal 422, a wideband CQI 426, a differential PMI 428, a rank index 440 and an ACK/NACK 424 may be transmitted in one (1) CCE 400. In a fourth feedback signal 430, an individual best M CQI 434, a differential PMI 436, a rank index 438 and an ACK/NACK 432 may be transmitted in three (3) CCEs 400.

Time and frequency resources used by a WTRU to report PMI and/or CQI may be controlled by an eNB. If the WTRU has a PUSCH allocation, the WTRU may transmit feedback bits on a scheduled PUSCH transmission with or without an associated scheduling grant or without an uplink shared channel (UL-SCH). The WTRU may transmit feedback on a PUCCH if it does not have PUSCH allocation.

Reporting may be periodic or aperiodic. When reporting in aperiodic mode, the WTRU may use the PUSCH. However, when reporting in periodic mode, the WTRU may use the PUSCH or the PUCCH. If both periodic and aperiodic reporting occurs in the same subframe, the WTRU may only transmit the aperiodic report in that particular sub-frame.

The set of resource block groups (RBGs) that a WTRU may evaluate for CQI reporting may be semi-statically configured by a higher layers, such as a medium access layer (MAC) or a radio link control (RLC). The term RBG and subband are interchangeable in the content of this disclosure. A number of resource blocks (k) in each resource block group may also be semi-statically configured by a higher layer.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

1. A method of feedback in a wireless transmit receive unit (WTRU), the method comprising:
transmitting a feedback bit over a predefined control channel element (CCE) wherein the feedback bit is one of a channel quality indicator (CQI), a precoding matrix index (PMI) or a rank index.

2. The method as in claim 1, wherein the feedback is transmitted over a plurality of aggregated predefined CCEs.

3. The method as in claim 1 wherein the feedback includes a CQI and a PMI.

4. The method as in claim 1 wherein the feedback includes a CQI, a PMI and a rank index.

5. The method as in claim 1 wherein the feedback includes an acknowledge/negative-acknowledge (ACK/NACK) signal.

6. The method as in claim 2 wherein the number of predefined CCEs used for feedback is determined at a feedback instance.

7. The method as in claim 6 further comprising determining the number of predefined CCEs used for feedback based on a number of feedback bits to be transmitted in the feedback instance.

8. The method as in claim 1 further comprising:
determining a wideband CQI, wherein the wideband CQI is an average of all CQIs across a bandwidth; and
transmitting the wideband CQI in at least one CCE.

9. The method as in claim 1 further comprising:
determining a first frequency-selective subband CQI, wherein the first frequency-selective subband CQI is an average of best M CQIs from among a plurality of subbands across a predetermined bandwidth, where M is an integer; and
transmitting the first frequency-selective subband CQI in a least one CCE.

10. The method as in claim 1 further comprising:
determining a second frequency-selective subband CQI, wherein the second frequency-selective subband CQI is a best M individual CQI selected from among a plurality of subbands, where M is an integer; and
transmitting the second frequency-selective subband CQI in a least one CCE.

11. The method as in claim 9 wherein the integer M varies depending on at least one system factor.

12. The method as in claim 11 wherein the system factor is based on system load and a quality of service (QoS) of the WTRU.

13. The method as in claim 10 wherein the integer M varies depending on at least one system factor.

14. The method of claim 13 wherein the system factor is based on system load and a quality of service (QoS) of the WTRU.

15. The method as in claim 1 further comprising:
determining a PMI; and
transmitting the PMI in at least one CCE.

16. The method as in claim 1 further comprising:
determining a differential PMI; and
transmitting the differential PMI in at least one CCE.

17. A method of reporting feedback by a wireless transmit receive unit (WTRU), the method comprising:
defining at least one channel control element (CCE);
aggregating the at least one CCE; and
transmitting a feedback signal on the at least one aggregated CCE.

18. The method of claim 17 further comprising the WTRU:
determining a channel quality index (CQI);
determining a precoding matrix index (PMI); and
transmitting the CQI and the PMI on the at least one aggregated CCE.

19. The method as in claim 18 wherein the CQI is a wideband CQI.

20. The method as in claim 18 wherein the CQI is a subband CQI.

21. The method as in claim 18 wherein the PMI is a differential PMI.

22. The method as in claim 18 further comprising the WTRU:
determining an acknowledge/negative-acknowledge (ACK/NACK) signal; and
transmitting the ACK/NACK with the CQI and the PMI on the at least one aggregated CCE.

23. A wireless transmit receive unit (WTRU) comprising:
a processor configured to define at least one channel control element (CCE) and aggregate the at least one defined CCE; and
a transmitter configured to transmit a feedback signal on the at least one aggregated CCE.

24. The WTRU of claim 23 wherein the processor is further configured to determine a channel quality index (CQI) and a precoding matrix index (PMI), and the transmitter is further configured to transmit the CQI and the PMI on the at least one aggregated CCE.

25. The WTRU as in claim 24 wherein the CQI is a wideband CQI.

26. The WTRU as in claim 24 wherein the CQI is a subband CQI.

27. The WTRU as in claim 24 wherein the PMI is a differential PMI.

28. The WTRU as in claim 24 wherein the processor is further configured to determine an acknowledge/negative-acknowledge (ACK/NACK) signal, and the transmitter is further configured to transmit the ACK/NACK with the CQI and the PMI on the aggregated CCEs.
